(19) United States
(12) Patent Application Publication
(10) Pub. No.: US 2025/0096636 A1
(43) Pub. Date: Mar. 20, 2025

(54) MOTOR AND MOTOR ASSEMBLY

(71) Applicant: YAMAHA HATSUDOKI KABUSHIKI KAISHA, Iwata-shi (JP)

(72) Inventors: Shinichi KUROSAWA, Shizuoka (JP); Shogo TANINO, Shizuoka (JP); Takuro KAMICHIKA, Shizuoka (JP)

(21) Appl. No.: 18/962,913

(22) Filed: Nov. 27, 2024

Related U.S. Application Data
(63) Continuation of application No. PCT/JP2023/019589, filed on May 25, 2023.

(30) Foreign Application Priority Data
May 31, 2022 (JP) 2022-089020

(51) Int. Cl. H02K 5/20; H02K 1/20; H02K 1/32

(52) U.S. Cl. CPC H02K 5/20; H02K 1/20; H02K 1/32

(57) ABSTRACT

A motor assembly includes axially connected motors each including a rotor and a stator inside a housing. A cooling medium pump is on the housing, at least a portion of which radially overlaps a stator coil of the stator. The housing includes walls, a total height of which is greater than a protruding amount of the cooling medium pump from an outer surface of the housing. The cooling medium pump includes a driven gear engaged with a driving gear attached to a rotor shaft of the rotor. A rotation sensor is located on an axially opposite side of the housing from the cooling medium pump, at least a portion of which axially overlaps an outer perimeter of and radially overlaps an inner perimeter of the driven gear of an adjacent motor.

### CROSS REFERENCE TO RELATED APPLICATIONS

This application claims the benefit of priority to Japanese Patent Application No. 2022-089020 filed on May 31, 2022 and is a Continuation Application of PCT Application No. PCT/JP2023/019589 filed on May 25, 2023. The entire contents of each application are hereby incorporated herein by reference.

### BACKGROUND OF THE INVENTION

### 1. Field of the Invention

The present invention relates to motors and motor assemblies, and more specifically to axially connectable motors and motor assemblies including the same.

### 2. Description of the Related Art

As an example which is pertinent to conventional techniques of this kind, JP-A 2021-516940 discloses an electric motor for use in an electric vehicle. The electric motor includes a first electric motor module including a first rotor having a first rotor shaft, and a second electric motor module including a second rotor having a second rotor shaft, with the first rotor shaft and the second rotor shaft connected with each other by a shaft connecting structure in a shape-bonding fashion. Also, the electric motor has a cooling channel for a cooling medium to flow through.

JP-A 2021-516940 discloses an electric motor including a plurality of axially connected electric motor modules in which a cooling medium flows through a cooling channel. However, there is no description of an arrangement of providing a cooling medium pump.

### SUMMARY OF THE INVENTION

Example embodiments of the present invention provide motors which are compact in their axial dimension even when a cooling medium pump is provided, and motor assemblies including the same.

According to an example embodiment of the present invention, an axially connectable motor includes a housing, a rotor located in the housing and including a rotor shaft and a rotor core radially outside the rotor shaft, a stator located in the housing and including a stator core radially outside the rotor and a stator coil wound around the stator core, and a cooling medium pump on the housing and drivable by rotation of the rotor shaft. With this arrangement, at least a portion of the cooling medium pump radially overlaps the stator coil.

At least a portion of the cooling medium pump on the housing radially overlaps the stator coil, and therefore it is possible, even when the cooling medium pump is provided, to keep an axial dimension of the motor compact and increase the space efficiency of the housing.

Preferably, the motor further includes a wall protruding axially from at least one of two axial ends of the housing. With this arrangement, the cooling medium pump is located outside the housing, and a total height of the wall is greater than an amount of protrusion of the cooling medium pump from an outer surface of the housing. In this case, the arrangement makes it possible to increase the space efficiency when axially connecting the motors and connect the motors without increasing an axial dimension of the motor.

Further preferably, the motor further includes a driving gear attached coaxially to the rotor shaft so as not to protrude axially from an end of the rotor shaft and drivable by the rotor shaft, and a driven gear attached coaxially to the cooling medium pump and drivable by engagement with the driving gear. In this case, it is possible to transmit a driving power from the rotor shaft to the cooling pump smoothly via the driving gear and the driven gear without increasing the axial dimension of the motor.

Further, preferably, the motor further includes a stator flow path to introduce a cooling medium to the stator. With this arrangement, the stator flow path includes an inlet on one radial side of the housing, an outlet on an opposing radial side of the housing, and a flow path to introduce the cooling medium from the inlet to the outlet along a coil end of the stator coil. In this case, it is possible to efficiently cool the coil end and its surroundings by introducing the cooling medium from outside the housing through the inlet in the housing, and to discharge the cooling medium from the outlet in the housing.

Preferably, the inlet includes a first inlet at a first axial end of the stator coil and a second inlet at a second axial end of the stator coil, the outlet includes a first outlet at the first axial end of the stator coil and a second outlet at the second axial end of the stator coil, and the flow path includes a first flow path extending from the first inlet to the first outlet and a second flow path extending from the second inlet to the second outlet. In this case, it is possible to efficiently cool the stator coil ends and their surroundings at both axial regions.

Further preferably, the motor further includes a rotor flow path extending axially through the rotor shaft for the cooling medium to flow through the rotor. In this case, it is possible to cool the rotor, especially the rotor shaft, efficiently with a simple configuration.

Further, preferably, the motor further includes a rotor flow path for the cooling medium to flow through the rotor. With this arrangement, the rotor shaft is hollow, and includes a partition wall dividing an interior thereof into an upstream side and a downstream side, a first through-hole on the upstream side of the partition wall, and a second through-hole provided on the downstream side of the partition wall. The rotor core includes a bypass flow path to connect the first through-hole with the second through-hole, and the rotor flow path extends from an upstream-side interior of the rotor shaft, through the first through-hole, the bypass flow path and the second through-hole, to a downstream-side interior of the rotor shaft. In this case, it is possible to cool the rotor shaft and the rotor core of the rotor entirely at high efficiency.

Preferably, when a plurality of motors are connected axially, the rotor flow paths of mutually adjacent motors communicate with each other. In this case, it is possible to cool the rotor of each motor efficiently with a simple configuration.

Further preferably, the motor further includes a housing flow path inside the housing, extending in a circumferential direction to allow the cooling medium to flow inside the housing, and radially overlapping the stator core. In this case, it is possible to cool inside of the housing efficiently while contributing to cooling of the stator core.

Further, preferably, when a plurality of motors are connected axially, the housing flow paths of mutually adjacent motors are independent from each other without communicating with each other. In this case, it is possible to sufficiently cool the housing for each motor.

Also, there is provided a motor assembly obtained by axially connecting a plurality of the motors described above. With this arrangement, each motor further includes a rotation sensor in the housing on an axially opposite side to the cooling medium pump, the driven gear in each motor has an annular outer perimeter engaged with the driving gear, and a truncated cone-shaped inner perimeter attached to the cooling medium pump, and at least a portion of the rotation sensor axially overlaps the outer perimeter of the driven gear in the adjacent motor, and radially overlaps the inner perimeter thereof.

In an example embodiment, in the motor assembly including an axially connected plurality of the motors each including the cooling pump and the rotation sensor, it is possible to keep an axial dimension of the motor assembly compact.

In example embodiments of the present invention, axial and radial refer to an axial direction and a radial direction of the rotor shaft.

The total height of the wall refers to, if the housing has both axial ends provided with the walls, a sum of the heights of both walls whereas if the housing has only one of the axial ends provided with the wall, the total height refers to the height of that wall. The height of the wall refers to a length of axial protruding amount of the wall from an outer surface of the housing.

According to example embodiments of the present invention it is possible to obtain motors which are compact in its axial dimension even when cooling medium pumps are provided, and motor assemblies including the same.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an axial sectional view of a motor according to an example embodiment of the present invention.

FIG. 2 is a side view of the motor in FIG. 1.

FIG. 3 is a sectional view along line A1-A1 of the motor in FIG. 1.

FIG. 4 is a sectional view along line B-B of the motor in FIG. 1.

FIG. 5 is an axial sectional view of a motor assembly in which a plurality of the motor in FIG. 1 are axially connected.

FIG. 6 is a side view of the motor assembly in FIG. 5.

FIG. 7 is an axial sectional view which shows a motor according to another example embodiment of the present invention.

FIG. 8 is a sectional view along line A2-A2 of the motor in FIG. 7.

FIG. 9 is an axial sectional view of a motor according to still another example embodiment of the present invention.

FIG. 10 is a sectional view along line A3-A3 of the motor in FIG. 9.

### DETAILED DESCRIPTION OF THE EXAMPLE EMBODIMENTS

Hereinafter, example embodiments of the present invention will be described with reference to the drawings.

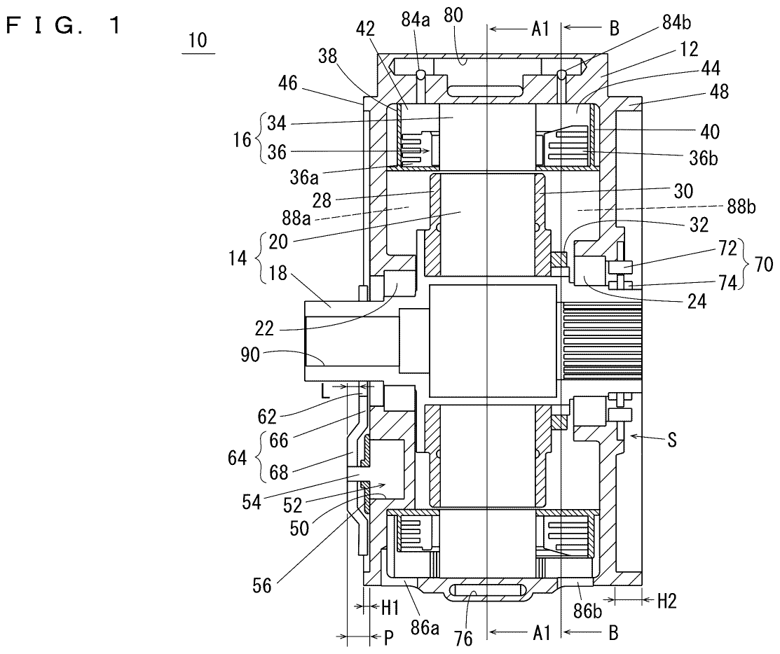

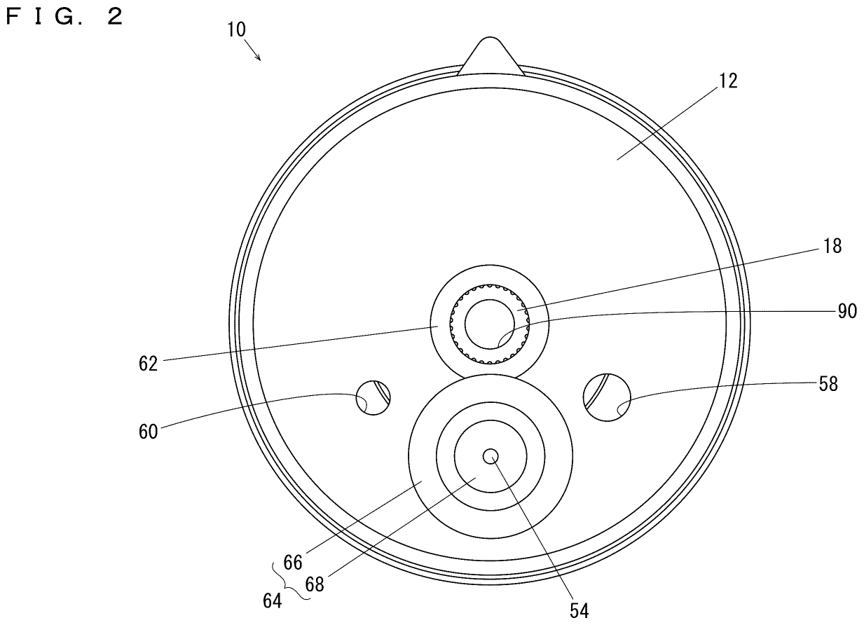

Referring to FIG. 1 and FIG. 2, a motor 10 according to an example embodiment of the present invention is an axially connectable motor and includes a housing 12. A rotor 14 and a stator 16 are located inside the housing 12.

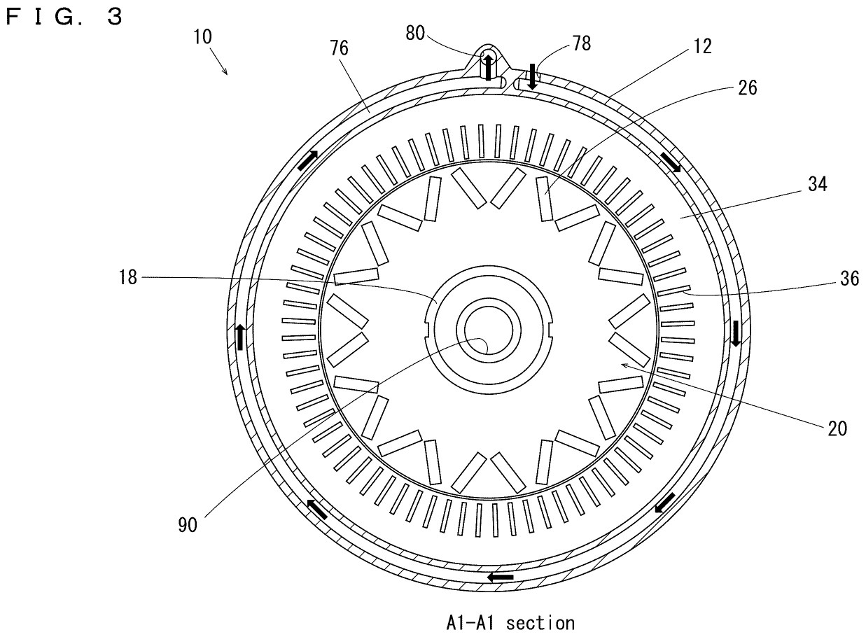

The rotor 14 includes a rotor shaft 18 and a rotor core 20 radially outside the rotor shaft 18. The rotor shaft 18 is rotatably held by the housing 12 via bearings 22, 24. The rotor core 20 includes a plurality of magnets 26 (see FIG. 3). End plates 28, 30 are disposed at two axial ends of the rotor core 20. A collar 32 is fitted around the rotor shaft 18 to prevent the rotor core 20 from becoming dislodged.

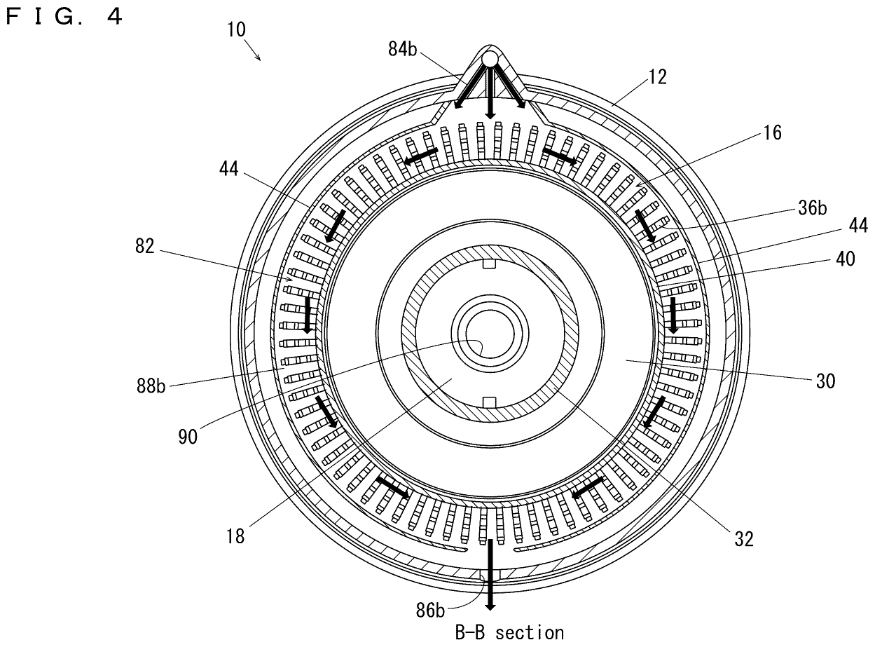

The stator 16 includes a stator core 34 radially outside the rotor 14 and fixed to an inner circumferential surface of the housing 12, and a stator coil 36 wound around the stator core 34. Coil end covers 38, 40, 42, 44 cover two axial ends of the stator coil 36, i.e., coil ends 36a, 36b. More specifically, referring to FIG. 1 and FIG. 4, the coil end cover 38 covers an inner circumference and an axial end of the plurality of coil ends 36a. The coil end cover 40 covers an inner circumference and an axial end of the plurality of coil ends 36b. Two coil end covers 42 cover an outer circumference of the plurality of coil ends 36a. Two coil end covers 44 cover an outer circumference of the plurality of coil ends 36b. In this arrangement, as understood from FIG. 4, the plurality of annularly disposed coil ends 36b are covered by the two coil end covers 44 except for upper and lower regions. Likewise, the plurality of annularly disposed coil ends 36a are covered by the two coil end covers 42 except for upper and lower regions.

Referring to FIG. 1, the housing 12 has two axial ends at which axially protruding walls 46, 48 are located.

At one axial end surface of the housing 12, a recess 50 is provided. A cooling medium pump 52 is located in the recess 50 and is drivable by rotation of the rotor shaft 18. The cooling medium pump 52 is located outside of the housing 12. At least a portion of the cooling medium pump 52 radially overlaps the stator coil 36. More specifically, at least a portion of the cooling medium pump 52 radially overlaps the coil end 36a. With the walls 46, 48 having their height respectively represented by H1, H2, and an amount of protrusion of the cooling medium pump 52 from an outer surface of the housing 12 represented by P, a total height (H1+H2) of the walls 46, 48 is greater than the amount of protrusion P of the cooling medium pump 52 from the outer surface of the housing 12. The cooling pump 52 is covered by a cover 56 except for its pump shaft 54. Near or adjacent to the recess 50 of the housing 12, through-holes 58, 60 are provided (see FIG. 2) to allow a cooling medium to pass through.

A driving gear 62 is attached coaxially to the rotor shaft 18 so as not to protrude axially from an end of the rotor shaft 18. The driving gear 62 is drivable by the rotor shaft 18. A driven gear 64 is attached coaxially to the cooling medium pump 52. The driven gear 64 has an annular outer perimeter 66 that engages with the driving gear 62, and a truncated cone-shaped inner perimeter 68 attached to the cooling medium pump 52. The driven gear 64 is drivable in engagement with the driving gear 62 to drive the cooling medium pump 52.

In the housing 12, a rotation sensor 70 is provided on the axially opposite side to the cooling medium pump 52. The rotation sensor 70 is located between the housing 12 and the rotor shaft 18 and configured as a resolver to detect a rotation angle of the rotor shaft 18. The rotation sensor 70 includes a resolver stator 72 attached to the housing 12, and a resolver rotor 74 attached to the rotor shaft 18.

The motor 10 is provided with a cooling medium flow path as will be described below. The motor 10 uses oil as a cooling medium which flows through a housing flow path 76, a stator flow path 82, and a rotor flow path 90 which will be described below.

Referring to FIG. 1 and FIG. 3, the housing flow path 76 is provided inside the housing 12 in a circumferential direction to allow the cooling medium to flow inside the housing 12. The housing flow path 76 has a belt-shaped pattern so as to radially overlap the stator core 34. The housing flow path 76 is supplied with the cooling medium from an inlet 78. After flowing through the housing flow path 76, the cooling medium is discharged from an outlet 80. The outlet 80 is wider than the housing flow path 76 at two axial sides of the housing flow path 76.

Referring to FIG. 1 and FIG. 4, the stator flow path 82 is provided inside the housing 12 to supply the cooling medium to the stator 16. The stator flow path 82 includes a plurality (two, in the present example embodiment) of inlets 84a, 84b communicating with the outlet 80 of the housing flow path 76 at one radial side of the housing 12, a plurality (two, in the present example embodiment) of outlets 86a, 86b at an opposing radial side of the housing 12, and a plurality (two, in the present example embodiment) of flow paths 88a, 88b to allow the cooling medium to flow along the coil ends 36a, 36b of the stator coil 36 from the inlets 84a, 84b to the outlets 86a, 86b. Referring to FIG. 4, the inlet 84b is above an upper portion of the plurality of annularly disposed coil ends 36b, i.e., a portion not covered by the two coil end covers 44, and branches in three directions. The outlet 86b is below a lower portion of the plurality of annularly disposed coil ends 36b, i.e., a portion not covered by the two coil end covers 44. In other words, the inlet 84b and the outlet 86b oppose to each other with the rotor shaft 18 in between. The flow path 88b is in a region sandwiched by the coil end covers 40 and 44. The inlet 84a, the outlet 86a, and the flow path 88a are arranged in the same way. As described above, the inlets 84a, 84b communicate with the outlet 80 of the housing flow path 76. The inlets 84a, 84b are provided correspondingly to the coil ends 36a, 36b respectively of the stator coil 36 located there above. The outlets 86a, 86b are provided correspondingly to the coil ends 36a, 36b respectively of the stator coil 36 located there below. The flow path 88a provides communication between the inlet 84a and the outlet 86a, while the flow path 88b provides communication between the inlet 84b and the outlet 86b. Therefore, the stator flow path 82 is supplied with the cooling medium which has passed through the housing flow path 76. After passing through the stator flow path 82, the cooling medium is discharged from the outlets 86a, 86b to the oil pan 92 (which will be described below).

Referring to FIG. 1, the rotor shaft 18 is hollow. In order to allow the cooling medium to flow to the rotor 14, the rotor shaft 18 includes an axially penetrating rotor flow path 90.

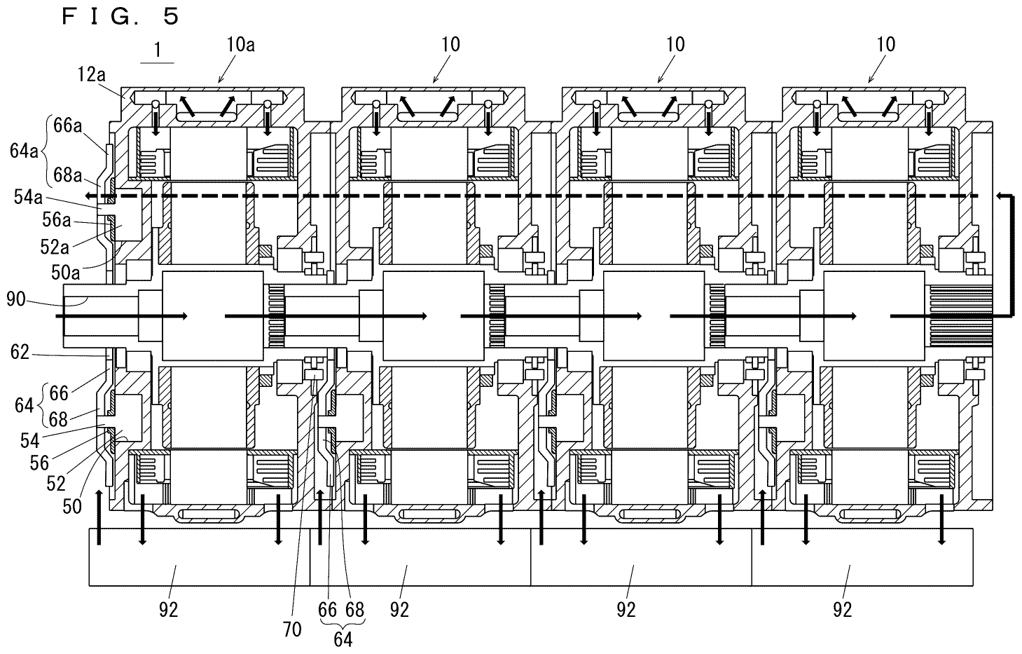

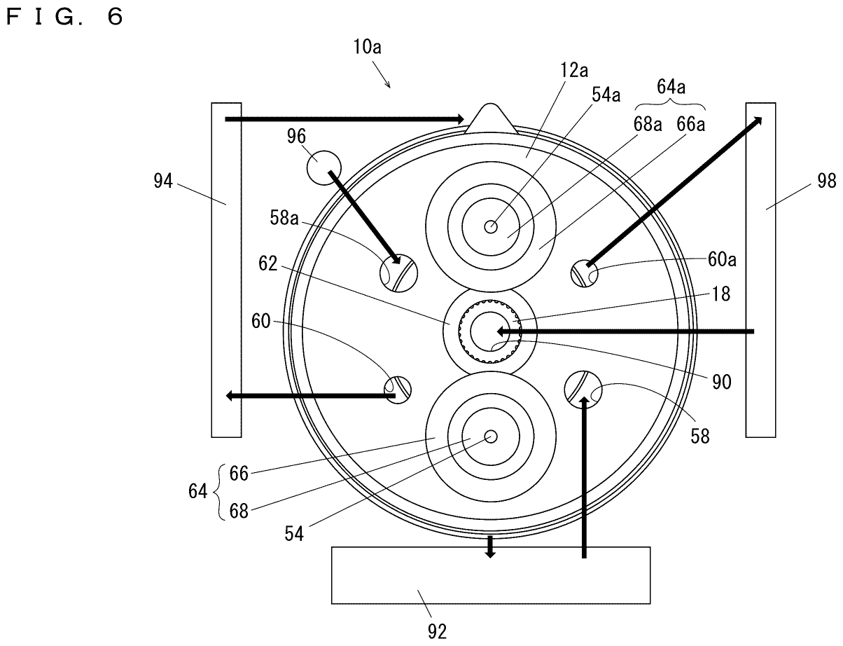

Referring to FIG. 5, a motor assembly 1 includes a motor 10a and a plurality (three, in the present example embodiment) of the motors 10. The motor 10a differs from the motor 10 in that it has a housing 12a in place of the housing 12. Referring to FIG. 5 and FIG. 6, the housing 12a is provided with an additional recess 50a in an axial end surface. Near the recess 50a of the housing 12a, through-holes 58a, 60a are provided to allow the cooling medium to pass through. The recess 50a of the housing 12a is provided with a cooling medium pump 52a to distribute the cooling medium through the rotor flow path 90. The cooling pump 52a is covered by a cover 56a except for its pump shaft 54a. A driven gear 64a, which is drivable by the driving gear 62 is attached to the cooling medium pump 52a. The cooling medium pump 52a and the driven gear 64a are configured the same way as the cooling medium pump 52 and the driven gear 64 respectively. The driven gear 64a includes an annular outer perimeter 66a engaged with the driving gear 62a, and a truncated cone-shaped inner perimeter 68a attached to the cooling medium pump 52a. All the other configurations of the motor 10a are identical with those of the motor 10. The motor 10a and the three motors 10 are axially connected by inserting the rotor shaft 18 of one of the mutually adjacent motors into the rotor shaft 18 of the other, to obtain the motor assembly 1.

Referring to FIG. 1 and FIG. 5, in the motor assembly 1, at least a portion of the rotation sensor 70 axially overlaps an outer perimeter 66 and radially overlaps an inner perimeter 68 of the driven gear 64 of the adjacent motor 10. In order for the inner perimeter 68 of the driven gear 64 of the inserting motor 10 is accommodated in a space S near the rotation sensor 70 without being blocked by the resolver stator 72 of the receiving motor 10 (10a), the inner perimeter 68 of the driven gear 64 protrudes an amount L from the surface of the driving gear 62.

Referring to FIG. 5 and FIG. 6, in the motor assembly 1, an oil pan 92 is disposed below each of the motors 10 (10a). In each motor 10 (10a), the cooling medium in the oil pan 92 is drawn in by the cooling medium pump 52, sent through the through-hole 58, and introduced into the cooling medium pump 52. Then, the cooling medium inside the cooling medium pump 52 is supplied to a respective one of radiators 94 through the through-hole 60, cooled therein, and then supplied to the housing flow path 76 from the inlet 78 (see FIG. 3). After passing through the housing flow path 76, the cooling medium passes through the outlet 80 and the inlets 84a, 84b of the stator flow path 82, into the flow paths 88a, 88b, and after passing through the flow paths 88a, 88b, returns to the oil pan 92 via the outlets 86a, 86b (see FIG. 1 and FIG. 4). In this way, the cooling medium is cyclically supplied to the housing flow path 76 and the stator flow path 82. Also, after passing through the rotor flow path 90, the cooling medium is supplied to the cooling medium pump 52a via an external pipe 96 and the through-hole 58a, then supplied by the cooling medium pump 52a to a radiator 98 via the through-hole 60a, where it is cooled and then returned to the rotor flow path 90. In this way, the cooling medium is cyclically supplied to the rotor flow path 90. It should be noted here that although FIG. 6 shows only one radiator 94 in order to avoid complicating the drawing, a radiator 94 is provided for each motor.

In the plurality of axially connected motors 10a, 10, housing flow paths 76 of mutually adjacent motors do not communicate with each other, i.e., the housing flow paths 76 are independent from each other. Likewise, the stator flow paths 82 in mutually adjacent motors are independent from each other without communicating with each other. On the other hand, in the plurality of axially connected motors 10, 10a, the rotor flow paths 90 of mutually adjacent motors communicate with each other.

According to the motor 10, at least a portion of the cooling medium pump 52 radially overlaps the stator coil 36, and therefore it is possible to keep an axial dimension of the motor 10 compact making it possible to increase the space efficiency of the housing 12.

The total height (H1+H2) of the walls 46, 48 is greater than the amount of protrusion P of the cooling medium pump 52 from the outer surface of the housing 12. Therefore, it is possible to increase the space efficiency when axially connecting the motors 10, making it possible to connect the motors 10 without increasing an axial dimension of each motor 10.

The driving gear 62 is attached coaxially to the rotor shaft 18 so as not to protrude axially from the end of the rotor shaft 18, while the driven gear 64 is coaxially attached to the cooling medium pump 52. Therefore, it is possible to transmit a driving power from the rotor shaft 18 to the cooling pump 52 smoothly via the driving gear 62 and the driven gear 64 without increasing the axial dimension of the motor 10.

The stator flow path 82 includes the inlets 84a, 84b provided on one radial side of the housing 12, the outlets 86a, 86b provided on an opposing radial side of the housing 12, and the flow paths 88a, 88b allow the cooling medium to flow from the inlets 84a, 84b to the outlets 86a, 86b along the coil ends 36a, 36b of the stator coil 36. Therefore, it is possible to efficiently cool the coil ends 36a, 36b and their surroundings by introducing the cooling medium from outside the housing 12 through the inlets 84a, 84b in the housing 12, and to discharge the cooling medium from the outlets 86a, 86b in the housing 12.

Each of the inlet 84a and the outlet 86a is provided correspondingly to the coil end 36a, each of the inlet 84b and the outlet 86b is provided correspondingly to the coil end 36b, the flow path 88a communicates between the inlet 84a and the outlet 86a, and the flow path 88b communicates between the inlet 84b and the outlet 86b. Therefore, it is possible to cool the coil ends 36a, 36b and their surroundings efficiently.

The rotor flow path 90 extends axially inside the rotor shaft 18. Therefore, it is possible to cool the rotor 14, especially the rotor shaft 18, efficiently with a simple configuration.

When a plurality of the motors 10 are connected axially, the rotor flow paths 90 of the mutually adjacent motors 10 communicate with each other. Therefore, it is possible to cool the rotor 14 in each motor 10 efficiently with a simple configuration.

The housing flow path 76 is provided inside the housing 12 in a circumferential direction to radially overlap the stator core 36. Therefore, it is possible to cool the inside of the housing 12 efficiently while also cooling the stator core 36.

When a plurality of the motors 10 are connected axially, the housing flow paths 76 of the mutually adjacent motors 10 are independent from each other without communicating with each other. Therefore, it is possible to sufficiently cool the housing 12 for each motor 10.

In each motor 10, the oil pan 92 and the radiator 94 can be used for dual purposes in supplying the cooling medium to the housing flow path 76 and the stator flow path 82.

The motor 10a also has the functions and advantages described above for the motor 10.

According to the motor assembly 1 which is configured by axially connected motors 10, 10a, at least a portion of the rotation sensor 70 axially overlaps the outer perimeter 66 of the adjacent motor 10 while radially overlapping the inner perimeter 68 of the driven gear 64. Therefore, in the motor assembly 1 configured by an axially connected plurality of the motors 10, 10a each including the cooling pump 52 and the rotation sensor 70, it is possible to keep an axial dimension of the motor assembly 1 compact.

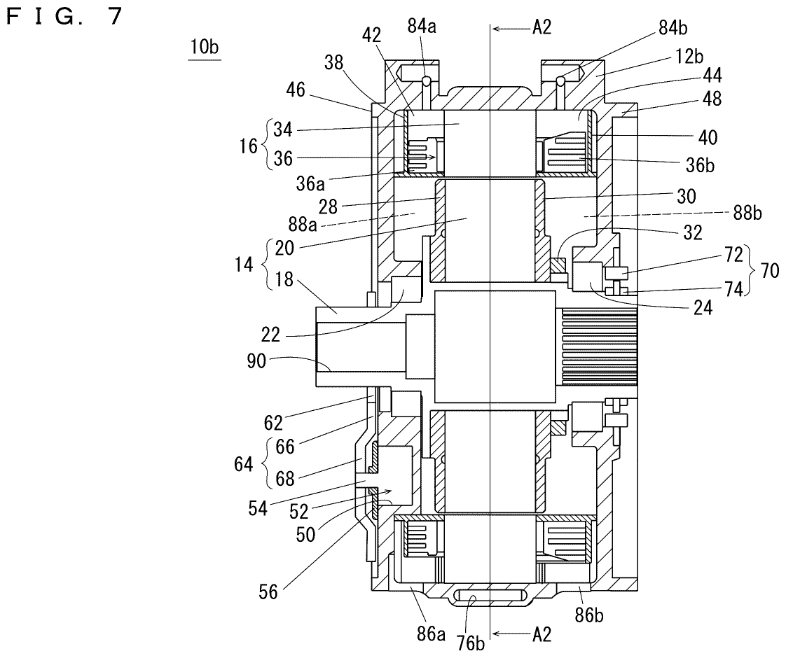

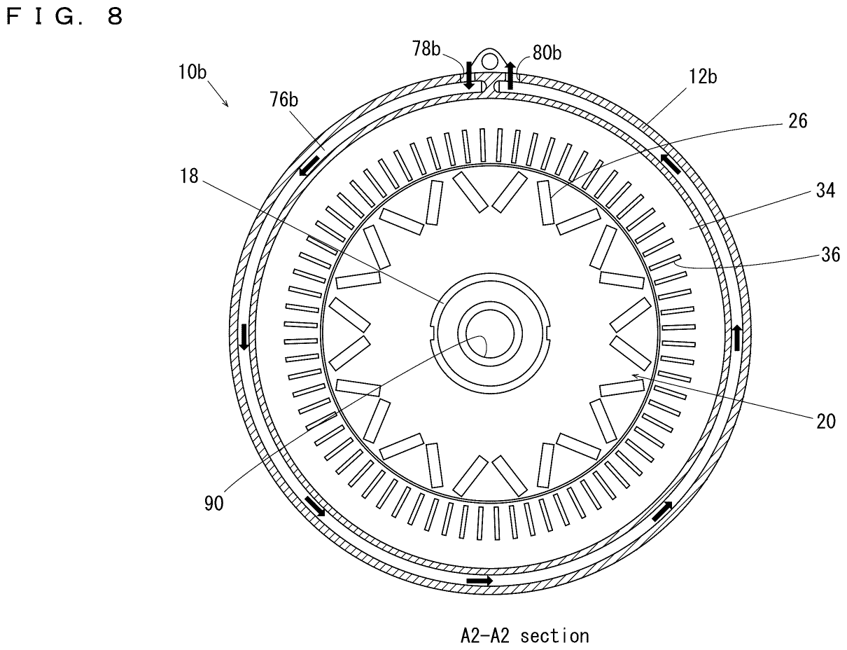

Next, description will be made for a motor 10b according to another example embodiment of the present invention with reference to FIG. 7 and FIG. 8. In the motor 10b, oil is used as the cooling medium to flow through the stator flow path 82 and the rotor flow path 90 whereas water is used as the cooling medium to flow through a housing flow path 76b (which will be described below).

The motor 10b differs from the motor 10 in that includes a housing flow path 76b, an inlet 78b, and an outlet 80b in place of the housing flow path 76, the inlet 78, and the outlet 80. In order to supply water to the housing flow path 76b, an unillustrated cooling medium pump and an unillustrated radiator are used separately per motor. Differing from the outlet 80, the outlet 80b does not communicate with the inlets 84a, 84b of the stator flow path 82 but communicates with the cooling medium pump. Therefore, after flowing through the housing flow path 76b, the water passes through the outlet 80b, flows through the cooling medium pump and the radiator, and then returns to the housing flow path 76b from the inlet 78b. In this way, water is cyclically supplied to the housing flow path 76b. Also, in the motor 10b, the oil from the radiator 94 is not supplied to the housing flow path 76b by the cooling medium pump 52, but is cyclically supplied to the stator flow path 82 (flow paths 88a, 88b) via the inlets 84a, 84b. All the other configurations of the motor 10b are identical with those in the motor 10, so no repetitive description will be repeated here.

According to the motor 10b, it is possible to use a cooling medium appropriate to the flow path, e.g., oil to flow through the stator flow path 82 and the rotor flow path 90 and water to flow through the housing flow path 76b.

It should be noted here that the motor 10a may also receive the same kind of modifications as have been made to change the motor 10 to the motor 10b such that it becomes possible to use oil for the stator flow path and the rotor flow path and use water for the housing flow path.

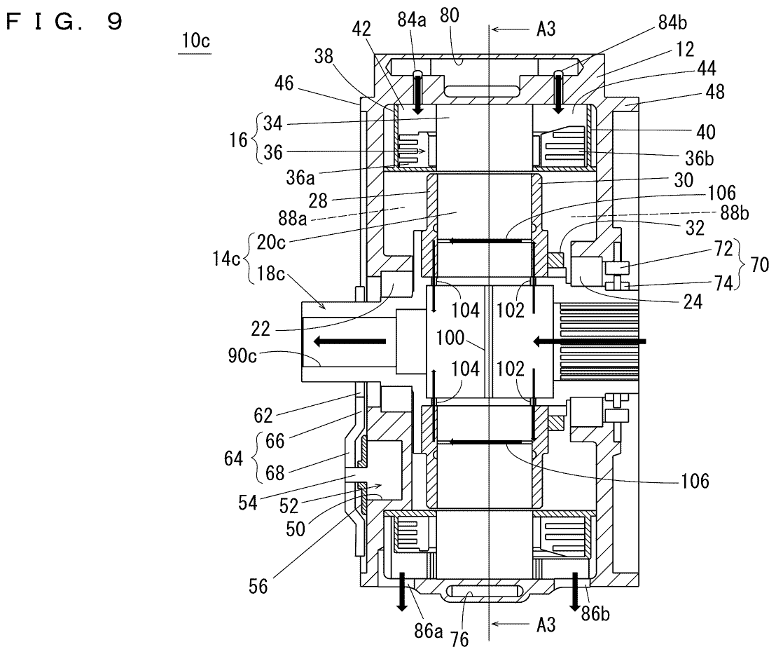

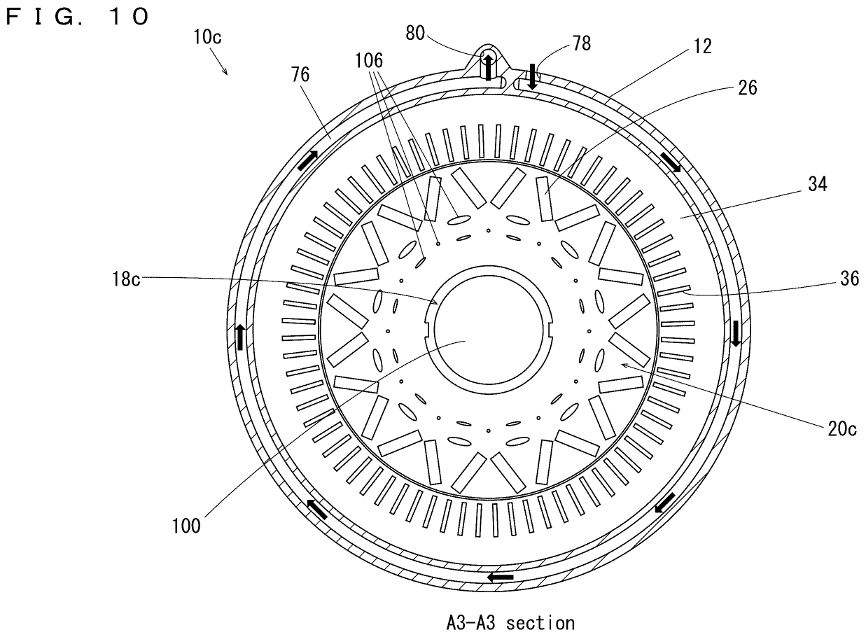

Further, description will be made for a motor 10c according to still another example embodiment of the present invention with reference to FIG. 9 and FIG. 10.

The motor 10c includes a rotor 14c in place of the rotor 14. The rotor 14c includes a rotor shaft 18c and a rotor core 20c. The rotor shaft 18c is hollow, and includes a partition wall 100 which divides an interior thereof into an upstream side and a downstream side, a plurality of first through-holes 102 provided on the upstream side of the partition wall 100, and a plurality of second through-holes 104 provided on the downstream side of the partition wall 100. The rotor core 20c includes a plurality of bypass flow paths 106 to connect each of the first through-holes 102 with a corresponding one of the second through-holes 104. In order to introduce a cooling medium to the rotor 14c, a rotor flow path 90c is provided from an upstream-side interior of the rotor shaft 18c, through the first through-hole 102, the bypass flow path 106 and the second through-hole 104, to a downstream-side interior of the rotor shaft 18c. All the other configurations of the motor 10c are identical with those in the motor 10, so no repetitive description will be repeated here.

According to the motor 10c, it is possible to cool the rotor shaft 18c and the rotor core 20c of the rotor 14c entirely at high efficiency.

It should be noted here that the motor 10b may also be modified like the motor 10c, i.e., the rotor shaft 18 includes a partition wall, first through-holes and second through-holes, the rotor core 20 includes bypass flow paths, and a rotor flow path is provided from an upstream-side interior of the rotor shaft 18 through the first through-hole, the bypass flow path and the second through-hole, to a downstream-side interior of the rotor shaft 18.

In the example embodiments described above, the walls are provided on both axial ends of the housing. However, the present invention is not limited by this. A wall may be provided only on one axial end of the housing. In this case, it is preferable that the height of the wall is greater than the amount of protrusion of the cooling medium pump from the outer surface of the housing.

Also, the cooling medium pump and the rotation sensor may be provided on a same axial side, i.e., together on one side or the other of the housing. In this case, it is possible to further decrease the axial dimension of the motor.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An axially connectable motor comprising:
a housing;
a rotor located in the housing and including a rotor shaft and a rotor core radially outside the rotor shaft;
a stator located in the housing and including a stator core radially outside the rotor, and a stator coil wound around the stator core; and
a cooling medium pump on the housing and drivable by rotation of the rotor shaft; wherein
at least a portion of the cooling medium pump radially overlaps the stator coil.

2. The motor according to claim 1, further comprising:
a wall on at least one of two axial ends of the housing and protruding axially from the housing; wherein
the cooling medium pump is outside the housing; and
a total height of the wall is greater than an amount of protrusion of the cooling medium pump from an outer surface of the housing.

3. The motor according to claim 1, further comprising:
a driving gear attached coaxially to the rotor shaft so as not to protrude axially from an end of the rotor shaft and drivable by the rotor shaft; and
a driven gear attached coaxially to the cooling medium pump and drivable by engagement with the driving gear.

4. The motor according to claim 1, further comprising:
a stator flow path to introduce a cooling medium to the stator; wherein
the stator flow path includes an inlet provided on one radial side of the housing, an outlet provided on an opposing radial side of the housing, and a flow path to introduce the cooling medium from the inlet to the outlet along a coil end of the stator coil.

5. The motor according to claim 4, wherein
the inlet includes a first inlet at a first axial end of the stator coil, and a second inlet at a second axial end of the stator coil;
the outlet includes a first outlet at the first axial end of the stator coil, and a second outlet at the second axial end of the stator coil; and
the flow path includes a first flow path from the first inlet to the first outlet, and a second flow path from the second inlet to the second outlet.

6. The motor according to claim 1, further comprising:
a rotor flow path axially extending through the rotor shaft to allow the cooling medium to flow through the rotor.

7. The motor according to claim 1, further comprising:
a rotor flow path for the cooling medium to flow through the rotor; wherein
the rotor shaft is hollow and includes:
a partition wall dividing an interior thereof into an upstream side and a downstream side;
a first through-hole on the upstream side of the partition wall; and
a second through-hole on the downstream side of the partition wall;
the rotor core includes a bypass flow path to connect the first through-hole with the second through-hole; and
the rotor flow path extends from an upstream-side interior of the rotor shaft, through the first through-hole, the bypass flow path and the second through-hole, to a downstream-side interior of the rotor shaft.

8. The motor according to claim 6, wherein, when a plurality of the motors are connected axially, the rotor flow paths of mutually adjacent motors communicate with each other.

9. The motor according to claim 1, further comprising:
a housing flow path inside the housing, extending in a circumferential direction to allow the cooling medium to flow inside the housing, and radially overlapping the stator core.

10. The motor according to claim 9, wherein, when a plurality of the motors are connected axially, the housing flow paths of mutually adjacent motors are independent from each other without communicating with each other.

11. A motor assembly comprising:
a plurality of the motors according to claim 3 axially connected; wherein
each of the plurality of motors includes a rotation sensor in the housing on an axially opposite side to the cooling medium pump;
the driven gear in each motor has an annular outer perimeter engaged with the driving gear, and a truncated cone-shaped inner perimeter attached to the cooling medium pump; and
at least a portion of the rotation sensor axially overlaps the outer perimeter of the driven gear in an adjacent motor, and radially overlaps the inner perimeter thereof.
